(19) United States
(12) Patent Application Publication
(10) Pub. No.: US 2019/0370235 A1
(43) Pub. Date: Dec. 5, 2019

(54) Information Processing Method and Apparatus

(71) Applicant: Huawei Technologies Co., Ltd., Shenzhen (CN)

(72) Inventors: Xinying Yang, Shenzhen (CN); Kuorong Chiang, Shenzhen (CN); Maozeng Li, Beijing (CN)

(21) Appl. No.: 16/541,728

(22) Filed: Aug. 15, 2019

Related U.S. Application Data
(63) Continuation of application No. PCT/CN2017/096736, filed on Aug. 10, 2017.

(30) Foreign Application Priority Data
Feb. 27, 2017 (CN) 201710109372.1

(51) Int. Cl. G06F 16/21; G06F 9/54; G06F 16/2453; G06F 11/34; G06K 9/62; G06N 20/00

(52) U.S. Cl. CPC G06F 16/217; G06F 9/545; G06F 16/24542; G06N 3/04; G06K 9/6257; G06K 9/6264; G06N 20/00; G06F 11/3409

(57) ABSTRACT

An information processing includes a kernel of a database management system that obtains target information, and determines creation information of a model of the target information according to the target information, where the model of the target information is used to estimate an execution cost of the target information. The creation information includes use information and training algorithm information of the model. The kernel sends a training instruction to an external trainer, and the external trainer then performs machine learning training on the data in the database according to the target information and the creation information of the model to obtain a first model of the target information.

### CROSS-REFERENCE TO RELATED APPLICATIONS

This application is a continuation application of International Application No. PCT/CN2017/096736, filed on Aug. 10, 2017, which claims priority to Chinese Patent Application No. 201710109372.1, filed on Feb. 27, 2017. The disclosures of the aforementioned applications are hereby incorporated by reference in their entireties.

### TECHNICAL FIELD

This application relates to the database field, and in particular, to an information processing method and apparatus.

### BACKGROUND

When a database is queried, and when a query statement such as an structured query language (SQL) query statement is received from a client, steps such as syntax analysis, pre-compiling, and optimization need to be performed on the query statement in order to generate an execution structure. As a most important component affecting execution efficiency of an SQL statement in a database system, an optimizer is configured to output an execution plan during compiling and the database system considers that the execution plan has a minimum cost. During operation, an executor performs a data operation according to the generated execution plan.

In a process of selecting an optimal execution plan by the optimizer, cost estimation is a very important step. In a cost estimation process, model training needs to be first performed according to a query statement, to obtain a training model of the query statement, and then cost estimation is performed according to the training model. At present, a common model training method for cost estimation is as follows: data sampling is performed in a database according to information to be optimized, for example, a query statement, and then model training is performed according to obtained sample data, that is, statistical information of the query statement in the sample data is collected. The statistical information may be statistical information based on a histogram, a common value, or a frequency.

The statistical information is only information obtained by means of training according to a small part of sample data in the database. Consequently, when cost estimation is performed using the statistical information, accuracy of an obtained cost parameter is relatively low, and an execution plan that is generated according to the cost parameter and that has a minimum cost may have redundancy to some extent. Further, when a data operation is performed according to the execution plan, execution efficiency of a corresponding SQL statement is relatively low. If model training is directly performed on all the data in the database using the foregoing model training method, because the database has a relatively large capacity, a lot of time is consumed, and a data operation progress is affected.

### SUMMARY

Embodiments of the present disclosure provide an information processing method and apparatus in order to improve accuracy of a cost parameter, and reduce impact on a data operation progress as much as possible.

To achieve the foregoing objective, the following technical solutions are used in the embodiments of the present disclosure:

According to a first aspect, an information processing method is provided and is applied to a database management system, where the database management system is configured to manage a database and includes a kernel, and the method includes: obtaining, by the kernel, target information, where the target information includes at least one of the following information: a target query statement, information about a query plan, distribution or change information of data in the database, or system configuration and environment information; determining, by the kernel, creation information of a model of the target information according to the target information, where the model of the target information is used to estimate a cost parameter of the target information, and the creation information includes use information and training algorithm information of the model of the target information: and sending, by the kernel, a training instruction to an external trainer, where the training instruction is used to instruct the external trainer to train the data in the database according to the target information and the creation information of the model of the target information using a machine learning method, to obtain a first model of the target information. Optionally, the training instruction may include the target information and/or the creation information of the model of the target information.

In the technical solution, when the database management system performs query optimization on the database, the kernel may determine, according to the obtained target information, the creation information of the model corresponding to the target information, and then sends the training instruction to the external trainer. The external trainer performs model training by means of machine learning in order to obtain the first model having relatively high accuracy such that when cost estimation is performed according to the first model, accuracy of the cost parameter can be improved, further, execution efficiency of the database is improved, and a data operation progress is not affected.

In a possible implementation of the first aspect, if a model information base is provided in the kernel, the model information base is used to store model information of the model obtained by means of machine learning training, and the method further includes: updating, by the kernel, the model information base according to the first model. In the possible technical solution, the kernel is associated with the external trainer using the model information base stored in the kernel, and stores model information of the first model in the model information base after model training is completed such that when performing query optimization, the kernel can directly perform optimization according to the model information stored in the model information base.

In a possible implementation of the first aspect, the determining, by the kernel, creation information of a model of the target information according to the target information includes: creating, by the kernel, the creation information of the model of the target information according to the target information; or obtaining, by the kernel, the creation information of the model of the target information from the model information base. In the possible technical solution, two methods for determining the creation information of the model of the target information are provided. When the creation information of the model of the target information does not exist, the creation information of the model of the target information may be created for the model of the target information; or when creation information of the first model exists, the creation information of the first model may be directly obtained from the model information base.

In a possible implementation of the first aspect, the updating, by the kernel, the model information base according to the first model includes: if model information of the model of the target information does not exist in the model information base, adding, by the kernel, model information of the first model to the model information base; or if model information of the model of the target information exists in the model information base, replacing, by the kernel, the model information of the model of the target information in the model information base with model information of the first model. In the possible technical solution, two possible methods for updating the model information base are provided. When the model information of the model of the target information does not exist in the model information base, the model information of the first model may be directly added; or when the model information of the model of the target information exists in the model information base, the model information of the model of the target information may be replaced with the model information of the first model.

In a possible implementation of the first aspect, after the determining, by the kernel, creation information of a model of the target information according to the target information, the method further includes: setting, by the kernel, a state of the model of the target information to an invalid state; and after the updating, by the kernel, the model information base according to the first model, the method further includes: setting, by the kernel, the state of the model of the target information to a valid state. In the possible technical solution, when the kernel triggers the external trainer to perform model training, the kernel does not wait for a returned training result but sets the state of the model of the target information to the invalid state, and sets the state of the model of the target information to the valid state after model training is completed such that statistical information collection and model training are asynchronously performed.

In a possible implementation of the first aspect, the method further includes: if the kernel determines that the model information of the model of the target information exists in the model information base and the state of the model of the target information is the valid state, obtaining, by the kernel, the model information of the model of the target information from the model information base; and determining, by the kernel, the cost parameter of the target information according to the model information of the model of the target information, where the cost parameter is used to generate an execution plan having a minimum cost. In the possible technical solution, when the kernel performs cost estimation using the first model obtained by means of machine learning training, accuracy of cost estimation can be improved, the execution plan having the minimum cost is further generated, and execution efficiency of the database management system can be improved according to the execution plan.

In a possible implementation of the first aspect, the method further includes: if a preset condition is satisfied, obtaining, by the kernel, statistical information corresponding to the target information from a statistical information base, where the statistical information base is used to store the statistical information that is of the target information and that is obtained by means of data sampling; and the preset condition includes: the model information of the model of the target information does not exist in the model information base, or the model information of the model of the target information exists in the model information base and the state of the model of the target information is the invalid state; and determining, by the kernel, the cost parameter of the target information according to the statistical information corresponding to the target information, where the cost parameter is used to generate an execution plan having a minimum cost. In the possible technical solution, when model training is performed using a machine learning method, a relatively long time may be needed. To avoid postponing and waiting by the kernel when model training is not completed, the kernel may obtain the statistical information corresponding to the target information from the statistical information base in order to increase a speed of cost estimation performed by the database management system.

In a possible implementation of the first aspect, the model information of the first model includes at least one of the following information: related column data, a model type, a quantity of layers of the model, a quantity of neurons, a function type, a model weight, a bias, an activation function, or a model state; or the model information of the first model is identifier meta information corresponding to the first model; or the model information of the first model is used to indicate a user-defined function associated with the first model. In the possible technical solution, several possible types of the model information of the first model are provided. The kernel can obtain the first model using the several possible types of information, and further perform cost estimation according to the first model.

According to a second aspect, a database management system is provided, where the database management system is configured to manage a database, and the database management system includes: an obtaining unit configured to obtain target information, where the target information includes at least one of the following information: a target query statement, information about a query plan, distribution or change information of data in the database, or system configuration and environment information: a determining unit configured to determine creation information of a model of the target information according to the target information, where the model of the target information is used to estimate a cost parameter of the target information, and the creation information includes use information and training algorithm information of the model of the target information; and a sending unit configured to send a training instruction to an external trainer, where the training instruction includes the target information and the creation information of the model of the target information and is used to instruct the external trainer to perform machine learning training on the data in the database according to the target information and the creation information of the model of the target information, to obtain a first model of the target information.

In a possible implementation of the second aspect, if a model information base is provided in the database management system, the model information base is used to store model information of the model obtained by means of machine learning training, and the database management system further includes: an update unit configured to update the model information base according to the first model.

In a possible implementation of the second aspect, the determining unit is configured to create the creation information of the model of the target information according to the target information; or obtain the creation information of the model of the target information from the model information base according to the target information.

In a possible implementation of the second aspect, the update unit is configured to, if model information of the model of the target information does not exist in the model information base, add model information of the first model to the model information base; or if model information of the model of the target information exists in the model information base, replace the model information of the model of the target information in the model information base with model information of the first model.

In a possible implementation of the second aspect, the database management system further includes: a setting unit configured to, after the determining unit determines the creation information of the model of the target information according to the target information, set a state of the model of the target information to an invalid state, where the setting unit is further configured to: after the update unit updates the model information base according to the first model, set the state of the model of the target information to a valid state.

In a possible implementation of the second aspect, the obtaining unit is further configured to, if the model information of the model of the target information exists in the model information base and the state of the model is the valid state, obtain the model information of the model of the target information from the model information base; and the determining unit is further configured to determine the cost parameter of the target information according to the model information of the model of the target information, where the cost parameter is used to generate an execution plan having a minimum cost.

In a possible implementation of the second aspect, the obtaining unit is further configured to: if a preset condition is satisfied, obtain statistical information corresponding to the target information from a statistical information base, where the statistical information base is used to store the statistical information that is of the target information and that is obtained by means of data sampling; and the preset condition includes: the model information of the model of the target information does not exist in the model information base, or the model information of the model of the target information exists in the model information base and the state of the model of the target information is the invalid state; and the determining unit is further configured to determine the cost parameter of the target information according to the statistical information corresponding to the target information, where the cost parameter is used to generate an execution plan having a minimum cost.

In a possible implementation of the second aspect, the model information of the first model includes at least one of the following information: related column data, a model type, a quantity of layers of the model, a quantity of neurons, a function type, a model weight, a bias, an activation function, or a model state; or the model information of the first model is identifier meta information corresponding to the first model; or the model information of the first model is used to indicate a user-defined function associated with the first model.

According to a third aspect, a database server is provided, including a kernel and an external trainer, where the kernel is configured to perform the information processing method provided according to any one of the first aspect or the possible implementations of the first aspect; the external trainer is configured to: when receiving a training instruction sent by the kernel, perform machine learning training on data in a database according to target information and creation information of a model of the target information, to obtain a first model of the target information.

According to a fourth aspect, a database server is provided, including a memory, a processor, a system bus, and a communications interface, where the memory stores code and data, the processor is connected to the memory using the system bus, and the processor runs the code in the memory such that the database server performs the information processing method provided according to any one of the first aspect or the possible implementations of the first aspect.

According to a fifth aspect, a computer readable storage medium is provided, where the computer readable storage medium stores computer execution instructions, and when at least one processor of a device executes the computer execution instructions, the device performs the information processing method provided according to any one of the first aspect or the possible implementations of the first aspect.

According to a sixth aspect, a computer program product is provided, where the computer program product includes computer execution instructions, the computer execution instructions are stored in a computer readable storage medium, at least one processor of a device may read the computer execution instructions from the computer readable storage medium, and the at least one processor executes the computer execution instructions such that the device performs the information processing method provided according to any one of the first aspect or the possible implementations of the first aspect.

It may be understood that any one of the apparatus, the computer storage medium, or the computer program product for an information processing method that is provided above is used to perform the corresponding method provided above. Therefore, for beneficial effects that can be achieved by the apparatus, the computer storage medium, or the computer program product, refer to beneficial effects of the corresponding method provided above, and details are not described herein again.

### BRIEF DESCRIPTION OF DRAWINGS

FIG. 1A is a schematic architectural diagram of a database system according to an embodiment of the present disclosure;

FIG. 1B is a schematic architectural diagram of another database system according to an embodiment of the present disclosure;

FIG. 1C is a schematic architectural diagram of still another database system according to an embodiment of the present disclosure;

FIG. 1D is a schematic architectural diagram of yet another database system according to an embodiment of the present disclosure;

FIG. 2A is a schematic structural diagram of a database server according to an embodiment of the present disclosure;

FIG. 2B is a schematic structural diagram of another database server according to an embodiment of the present disclosure;

FIG. 3 is a schematic diagram of a model of a neural network according to an embodiment of the present disclosure;

FIG. 4 is a flowchart of an information processing method according to an embodiment of the present disclosure;

FIG. 5 is a schematic diagram of creating creation information of a first model according to an embodiment of the present disclosure;

FIG. 6 is a flowchart of another information processing method according to an embodiment of the present disclosure;

FIG. 7 is a flowchart of still another information processing method according to an embodiment of the present disclosure;

FIG. 8 is a schematic diagram of performing an information processing method by a database management system according to an embodiment of the present disclosure;

FIG. 9 is a schematic structural diagram of a database management system according to an embodiment of the present disclosure; and

FIG. 10 is a schematic structural diagram of a database server according to an embodiment of the present disclosure.

### DESCRIPTION OF EMBODIMENTS

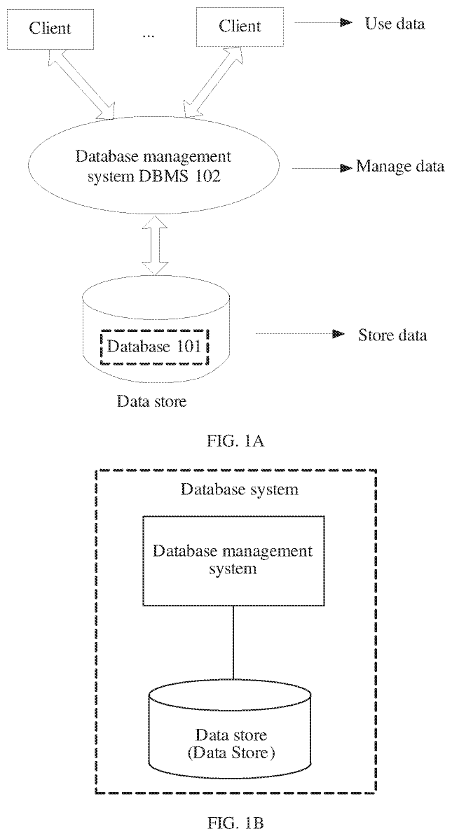

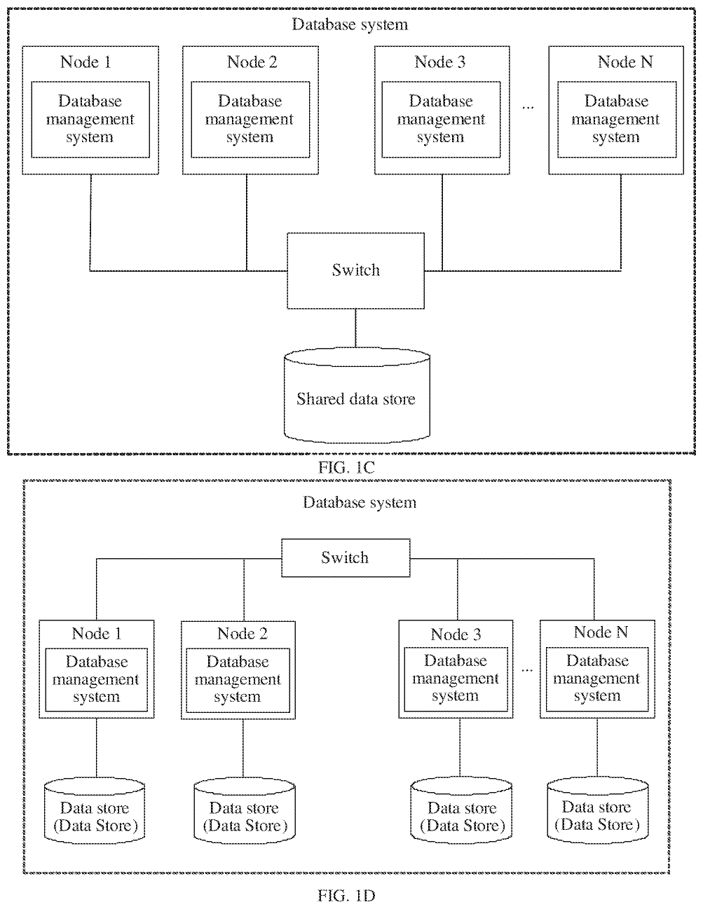

An architecture of a database system applied to embodiments of the present disclosure is shown in FIG. 1A. The database system includes a database 101 and a database management system (DBMS) 102.

The database 101 is an organized data set stored in a data store for a long time, that is, an associated data set that is organized, stored, and used according to a particular data model. For example, the database 101 may include one or more pieces of table data.

The DBMS 102 is configured to set up, use, and maintain the database 101, and uniformly manage and control the database 101 in order to ensure security and integrity of the database 101. A user may access data in the database 101 using the DBMS 102, and a database administrator also maintains the database using the DBMS 102. The DBMS 102 provides various functions such that multiple application programs and user equipment can set up, modify, and query the database using different methods at a same moment or at different moments. The application program and the user equipment may be collectively referred to as a client. The functions provided by the DBMS 102 may include the following several items: (1) a data definition function: the DBMS 102 provides a data definition language (DDL) to define a database structure, and the DDL is used to characterize a database frame and can be stored in a data dictionary; (2) a data access function: the DBMS 102 provides a data manipulation language (DML), to implement basic access operations such as retrieval, insertion, modification, and deletion on data in the database; (3) a database operation management function: the DBMS 102 provides a data control function, that is, control of security, integrity, concurrency, and the like of data to effectively control and manage operation of the database in order to ensure data correctness and validity; (4) a database setup and maintenance function, including loading of initial data in the database and functions such as dumping, recovery, re-organizing, system performance monitoring, and analysis of the database; and (5) database transmission: the DBMS 102 provides transmission of processed data, to implement communication between the client and the DBMS 102, and the database transmission is usually completed by cooperating with an operating system.

In an embodiment, FIG. 1B is a schematic diagram of a single-server database system. The single-server database system includes a database management system and a data store. The database management system is configured to provide a service such as query and modification of a database, and the database management system stores data in the data store. In the single-server database system, the database management system and the data store are usually located on a single server, for example, a symmetric multi-processor (SMP) server. The SMP server includes multiple processors. All the processors share resources such as a bus, a memory, and an I/O system. A function of the database management system may be implemented by one or more processors by performing a program in the memory.

FIG. 1C is a schematic diagram of a cluster database system using a shared storage architecture. The cluster database system includes multiple nodes (such as nodes 1 to N in FIG. 1C). A database management system is deployed in each node for respectively providing a service such as query and modification of a database to a user. Multiple database management systems store shared data in a shared data store, and perform a read/write operation on the data in the data store using a switch. The shared data store may be a shared disk array. The node in the cluster database system may be a physical machine such as a database server, or may be a virtual machine running on an abstract hardware resource. If the node is a physical machine, the switch is a storage area network (SAN) switch, an Ethernet switch, a fiber channel switch, or another physical switching device. If the node is a virtual machine, the switch is a virtual switch.

FIG. 1D is a schematic diagram of a cluster database system using a shared-nothing architecture. Each node has an exclusive hardware resource (such as a data store), an operating system, and a database. Nodes perform communication using a network. In the architecture, data is allocated to each node according to a database model and an application feature. A query task is divided into several parts, and the several parts are concurrently performed on all the nodes. The nodes perform calculation by cooperating with each other, and provide a database service as a whole. All communication functions are implemented in a high-broadband network interconnection architecture. Similar to the cluster database system of the shared disk architecture that is described in FIG. 1C, the node herein may be a physical machine or may be a virtual machine.

In all the embodiments of the present disclosure, the data store of the database system includes, but is not limited to, a solid-state drive (SSD), a disk array, or a non-transient computer readable medium of another type. Although the database is not shown in FIG. 1B to FIG. 1D, it should be understood that the database is stored in the data store. A person skilled in the art may understand that one database system may include fewer components or more components than those shown in FIG. 1B to FIG. 1D, or may include a component different from the components shown in FIG. 1B to FIG. 1D. FIG. 1B to FIG. 1D merely show components more related to implementations disclosed in the embodiments of the present disclosure. For example, although four nodes are already described in FIG. 1C and FIG. 1D, a person skilled in the art may understand that one cluster database system may include any quantity of nodes. Functions of database management systems of the nodes may be respectively implemented by a proper combination of software, hardware, and/or firmware that runs on the nodes.

A person skilled in the art may clearly understand according to teachings of the embodiments of the present disclosure that, a method in the embodiments of the present disclosure is applied to a database management system. The database management system may be applied to a single-server database system, a cluster database system of a shared-nothing architecture, a cluster database system of a shared-storage architecture, or a database system of another type.

Further, referring to FIG. 1A, when querying the database 101, the DBMS 102 usually needs to perform steps such as syntax analysis, pre-compiling, and optimization on a query statement, obtains, by means of estimation, an execution method having a cost that the database system considers to be minimum, and further generates an execution plan having the minimum cost. During operation, an execution structure performs a data operation according to the generated execution plan in order to improve performance of the database system. When performing cost estimation on the query statement, the DBMS 102 needs to collect statistical information of the query statement, and performs cost estimation according to the collected statistical information. A method for collecting the statistical information may be performing model training by means of machine learning to obtain model information, or may be obtaining the statistical information by means of data sampling and statistics collection. The model information may also be referred to as statistical information.

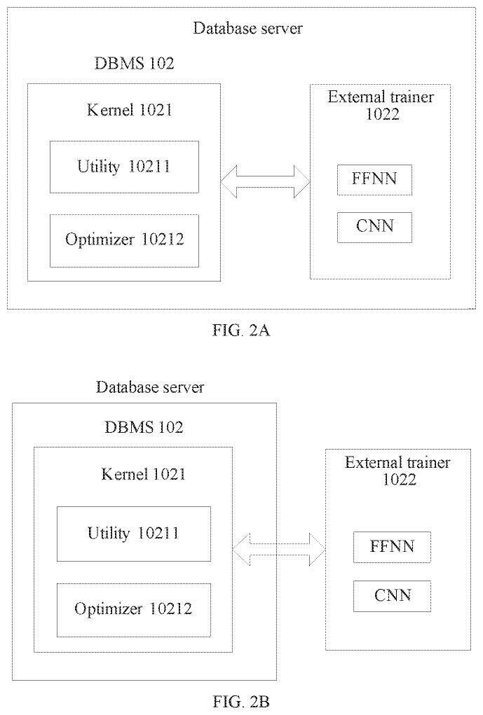

The DBMS 102 may be located in a database server. For example, the database server may be the SMP server in the single-server database system in FIG. 1B or the node in FIG. 1C or FIG. 1D. In an embodiment, as shown in FIG. 2A, the database server may include a kernel 1021 and an external trainer 1022 that is independent of the kernel 1021 and that is located in the database server. Alternatively, as shown in FIG. 2B, the database server includes a kernel 1021, and an external trainer 1022 is located outside the database server. The kernel 1021 is a core of the database server and may be configured to perform the various functions provided by the DBMS 102. The kernel 1021 may include a utility 10211 and an optimizer 10212. When the database server queries the database 101, the utility 10211 may trigger the external trainer 1022 to perform model training by means of machine learning in order to obtain model information of a training model. The optimizer 10212 may perform cost estimation according to the model information obtained by means of training performed by the external trainer 1022 in order to generate the execution plan having the minimum cost such that the execution structure performs the data operation according to the generated execution plan in order to improve the performance of the database system.

Machine learning is a process of obtaining a new inference model by relying on learning or observation of existing data. Machine learning may be implemented using multiple different algorithms, and common machine learning algorithms may include: models such as a neural network (NN) and a random forest (RF). For example, the neural network may include a feed forward neural network (FFNN) and a recurrent neural network (RNN). As shown in FIG. 3. FIG. 3 is a schematic diagram of a model of a neural network. The model may include an input layer, a hidden layer, and an output layer. The layers may include different quantities of neurons.

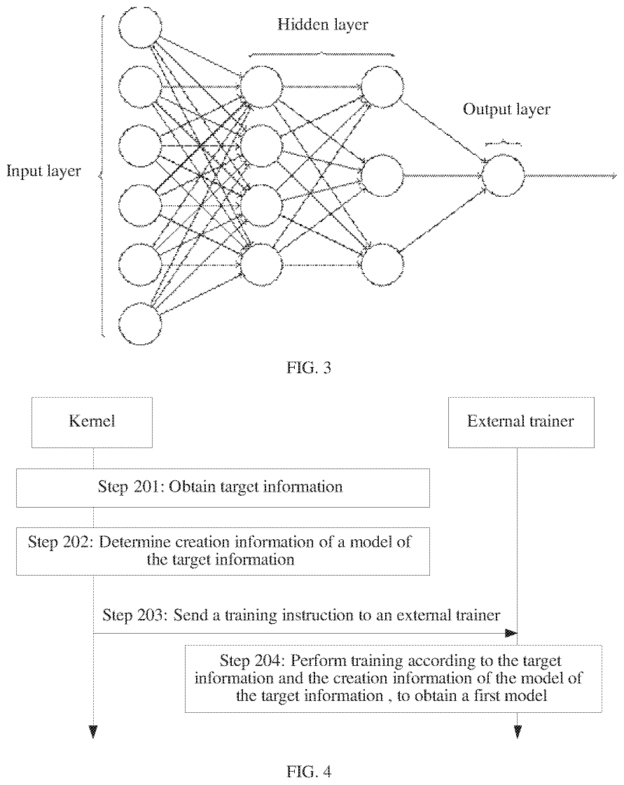

FIG. 4 is a flowchart of an information processing method according to an embodiment of the present disclosure. The method is applied to any one of the database systems shown in FIG. 1A to FIG. 1D. Referring to FIG. 4, the method includes the following several steps.

Step 201: A kernel of a database management system obtains target information. The target information includes at least one of the following information: a target query statement, information about a query plan, distribution or change information of data in a database, or system configuration and environment information.

The target query statement may be an SQL statement represented by a structured query language. During an embodiment application, the target query statement may include at least two related pieces of column data. The at least two related pieces of column data may be data in the database managed by the database management system. For example, using an SQL statement as an example, the two related pieces of column data may be represented as “C1=var1 AND C2=var2”. C1 and C2 are used to identify the two pieces of column data, and var1 and var2 respectively indicate values of the two pieces of column data.

The query plan is an execution plan generated after the database compiles and optimizes an SQL statement. An optimal execution plan of a new statement may be explored by means of machine learning and according to features of optimal execution plans corresponding to modes and features of lots of sample query statements.

The distribution information of data in a database is a hash degree of data content distribution and a distribution status on each distributed node. The data change information is a change tendency and feature of addition, deletion, and modification of the data. A distribution or change sample of the data may be learned by means of machine learning such that optimization of configuration of an internal parameter or a resource is completed. For example, a selectivity example in this embodiment of this specification is an embodiment of learning a data distribution feature (a correlation of multi-column data).

The system configuration information is a storage and computing capability indicator of specific hardware. The environment information is a system throughput and a processing capability of the system in different time periods or at different pressures. An internal parameter of the database system and a processing efficiency sample may be learned by means of machine learning and using sampling configuration and environment information in order to adjust and determine an internal parameter or a processing capability in a new environment or in future.

In an embodiment, the target information may be sent by a client, or may be information from the database management system. This is not limited in this embodiment of the present disclosure. For example, when the client needs to query the database, the client may send the target information to the database management system such that the kernel of the database management system receives the target information. The client may be user equipment, and that the client needs to query the database may mean that an application program in the user equipment queries the database.

Step 202: The kernel determines creation information of a model of the target information according to the target information. The model of the target information is used to estimate an execution cost of the target information, and the creation information includes use information and training algorithm information of the model of the target information.

When the kernel determines the creation information of the model corresponding to the target information, the kernel may query whether the creation information of the model of the target information exists. If the creation information of the model corresponding to the target information does not exist, it indicates that the database management system has not queried for the target information before, and the kernel may create the creation information of the model of the target information according to the target information. If the creation information of the model of the target information exists, it indicates that the database management system has queried for the target information before, and the database management system can directly obtain the creation information of the model of the target information according to the target information, for example, obtain the creation information from a model information base.

In addition, the creation information of the model of the target information may include information about multiple training parameters, and each training parameter may be represented by a field. Therefore, the creation information of the model of the target information may include multiple fields. An example in which the creation information of the model of the target information does not exist, and the kernel creates the creation information of the model of the target information according to the target information is used. The kernel may define the creation information of the model of the target information using a DDL. For example, the target information includes a target query statement. The kernel defines a model corresponding to the target query statement as a first model M1, defines a model use of the first model M1 as selectivity estimation, and determines a training algorithm of the first model as an FFNN; and a corresponding DDL statement may be: CREATE MODEL M1:SEL 2 FOR T1 (C1, C2) USING FFNN. In the DDL statement. SEL 2 FOR T1 (C1, C2) indicates that the model use of M1 is to estimate a selectivity of two pieces of column data C1 and C2. Later, the kernel may further define another field, for example, meta information such as a model weight, a bias, a neuron activation function used during model training, a quantity of layers of the model, a quantity of neurons, or model validity information, for the first model.

For example, if an identifier of the first model is ml, using an example in which multiple fields of the first model ml are defined using the DDL, the multiple fields defined by the database management system for the first model ml may be shown in the following Table 1. Data types of the multiple fields may be the same, or may be different. Each of the multiple fields corresponds to one unique identifier.

TABLE 1
First model ml

| Field | Datatype | Description |
|---|---|---|
| mlid | oid, | Unique machine learning tuple identifier |
| | not noll | |
| mlname | name, | Internal name of a machine learning model |
| | not noll | database created by using a creation |
| | | statement |
| mltype | int2 | Model use type (such as a multi-column |
| | | selectivity |
| mlfunctype | int2 | Training algorithm of the model |
| mlweight | realarray | Flatten model weight (array) |
| mlbias | realarray | Flatten model bias (array) |
| mlactfunctype | int2array | Neuron activation function (array) |
| mlneurons | int2array | Quantity of neurons at each layer |
| mlvalid | int2 | Model validity parameter |
| mlrelid | oid | Related table information |
| mllattnum | int2 | Related column information 1 of a |
| | | related table |
| mlrattnum | int2 | Related column information 2 of the |
| | | related table |

It should be noted that the multiple fields of the first model that are shown in Table 1 are merely an example, and are not intended to limit the embodiments of the present disclosure. In addition, when the database management system includes multiple models, multiple fields of the multiple models may be stored together, for example, stored in a system table.

The use information of the model of the target information is used to indicate a use type of the model. For example, using Table 1 as an example, the use information of the model of the target information is selectivity estimation such that a selectivity of the target information can be obtained according to the model, and cost estimation is performed based on the selectivity. The training algorithm information is used to indicate an algorithm used during model training performed by means of machine learning, an algorithm-related parameter, and the like. Using Table 1 as an example, the training algorithm information may include the neuron activation function and the quantity of neurons at each layer.

Further, the model information base may be provided in the kernel, and the model information base is used to store model information of a model obtained by means of machine learning training. The model information may be one of the following information: related column data, a model type, a quantity of layers of the model, a quantity of neurons, a function type, a model weight, a bias, an activation function, or a model state; or identifier meta information corresponding to each model; or a user-defined function associated with each model.

If training result parameter information and a predictive model function are both implemented outside the database, the identifier meta information is a unique identifier that is stored in the database system and that corresponds to the implementation. Related part during operation by an optimizer calls the corresponding external implementation according to the identifier. The user-defined function means that the predictive model function is implemented in a user-defined function manner. Related part during operation by the optimizer calls the function.

In addition, using an example in which the model information stored in the model information base is an embodiment model, when creating the creation information of the model of the target information for the target information, the database management system may create a new record in the model information base. The record may include multiple fields defined by the database management system for the model of the target information and content item information corresponding to each field.

During an embodiment of an application, when creating a new record in the model information base for the model of the target information, the database management system may configure corresponding content item information for multiple fields, directly fills content item information in a corresponding location for a field whose content item information is known before model training, and fills a default value in a corresponding location or make the corresponding location null for a field whose content item information is known after model training.

For example, in the multiple fields of the first model shown in Table 1, content item information corresponding to the mlid, the mlname, the mltype, and the mlfunctype is known before model training, and the database management system may directly fill the corresponding content item information in corresponding locations. Content item information corresponding to the mlweight, the mlbias, the mlactfunctype, and the mlneurons is unknown before model training and is known after model training is completed, and the database management system may fill in different default values according to the data types corresponding to the fields or make corresponding locations null.

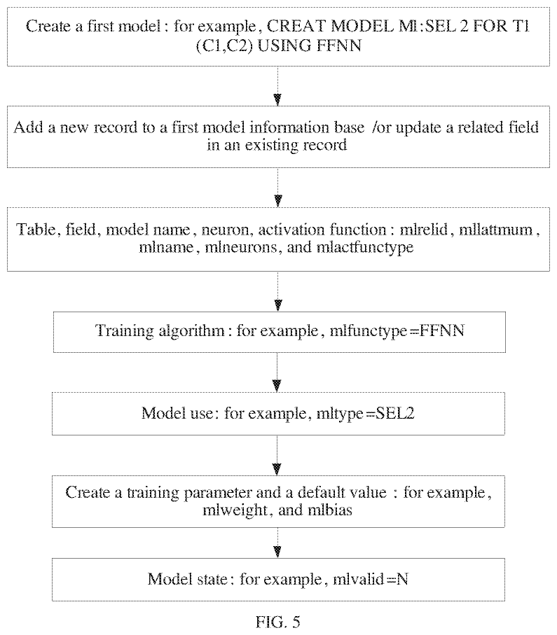

In an embodiment, when the model information base is provided in the database management system, a process of determining creation information of the first model corresponding to the target information by the database management system may be shown in FIG. 5. The first two steps in FIG. 5 is a process of model creation and registration in the model information base. After a CREATE statement is created, model-related meta information is first inserted or updated (if a same mlid already exists) in the model information base. Inserted or updated content is shown in other procedures in FIG. 5, and all newly-defined fields are filled in with values related to the model.

Using an example in which a DDL statement is: “CREAT MODEL M1:SEL 2 FOR T1 (C1, C2) USING FFNN” as an example, “T1” is filled in the mlrelid; bias numbers of C1 and C2 are respectively filled in the mllattnum and the mlrattnum; a model name “M1” is filled in the mlname; neuron information {6, 4, 1} is filled in the mlneurons array, indicating that an input layer has six neurons, a hidden layer has four neurons, and an output layer has one neuron; the mlactfunctype is filled in with, for example, {SIGMOID, SIGMOID, SIGMOID, SIGMOID, SIGMOID} according to neuron activation functions at the hidden layer and the output layer; SEL2 is filled in the model use, indicating the selectivity of the two pieces of column data; the FFNN is filled in the training algorithm of the model which is also referred to as the model type; parameters of the model weight and the model bias are set to null; and the model validity is set to N (an invalid state).

Further, after determining the creation information of the first model corresponding to the target information by means of step 202, the database management system may set a state of the first model to an invalid state. In an embodiment, the kernel of the database management system may perform step 202, and set the state of the first model to the invalid state.

Step 203: The kernel sends a training instruction to an external trainer.

Optionally, the training instruction may include the target information and the creation information of the model of the target information. During an embodiment of an application, the target information and the creation information of the model of the target information may be sent to the external trainer using a separate instruction or message. This is not limited in this embodiment of the present disclosure.

Step 204: When the external trainer receives the training instruction, the external trainer performs machine learning training on data in a database according to the target information and the creation information of the model of the target information, to obtain a first model of the target information.

After the kernel determines the creation information of the first model, the kernel may send the training instruction to the external trainer. When the external trainer receives the training instruction, the external trainer may import the data in the database as a trained object and use the target information and the creation information of the model of the target information as an input, to perform machine learning training on the data in the database in order to output the model of the model of the target information as the first model.

Further, in a process of obtaining the first model by the external trainer by means of machine learning training, the kernel may further perform data sampling in the database using a data sampling method and according to the target information, and collect statistical information according to data obtained by means of sampling. For example, the kernel may obtain statistical information based on a histogram, a common value, or a frequency.

In addition, the model training process may also be that the kernel imports the data in the database according to the target information and the creation information of the model of the target information, and obtains the first model by means of machine learning training. In this way, compared with a data sampling method in other approaches, accuracy of the first model can be improved, further, accuracy of a cost parameter for estimation is improved, and execution efficiency of the database management system is improved. In addition, in a process of training the first model by the kernel, the kernel may further set a state of the first model to a training state, for example, set the state of the first model to T (Training). The training state may be considered as an invalid state. When the kernel completes the training of the first model and obtains parameter information of a training parameter corresponding to the first model, the kernel may set the state of the first model to a valid state.

In this embodiment of the present disclosure, when the database management system performs query optimization on the database, the kernel may determine, according to the obtained target information, the creation information of the model of the target information, and then sends the training instruction to the external trainer. The external trainer performs model training by means of machine learning in order to obtain the first model having relatively high accuracy such that when cost estimation is performed according to the first model, accuracy of the cost parameter can be improved, further, execution efficiency of the database is improved, and a data operation progress is not affected. In addition, when the kernel triggers the external trainer to perform model training, the kernel does not wait for a returned training result but sets the state of the model of the target information to the invalid state, and sets the state of the model of the target information to the valid state after model training is completed such that statistical information collection and model training are asynchronously performed.

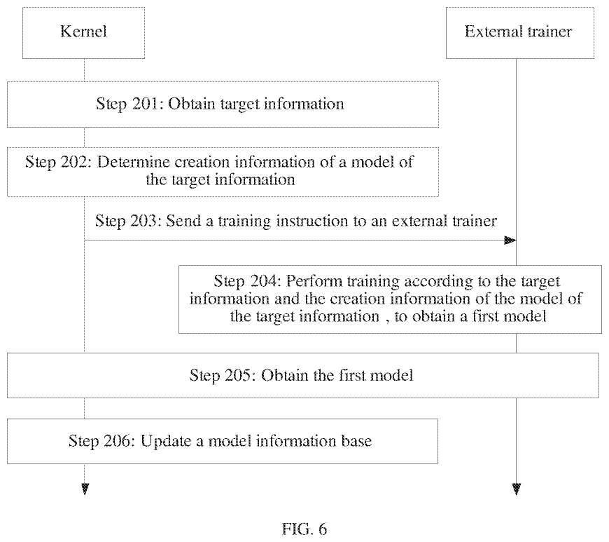

Further, referring to FIG. 6, if a model information base is provided in the kernel, and the model information base is used to store model information of the model obtained by means of machine learning training, after step 203, the method further includes: step 205 and step 206.

Step 205: The kernel obtains the first model.

The kernel may obtain the first model by performing multiple different methods. In an embodiment, the external trainer may send the first model to the kernel such that the kernel receives the first model. Alternatively, the external trainer stores the first model in a specified file (for example, a configuration file) outside the kernel. The kernel may read the first model from the specified file. For example, the kernel may read the first model from the specified file according to a model identifier of the first model.

Step 206: The kernel updates the model information base according to model information of the first model.

If model information of the model of the target information does not exist in the model information base, the kernel adds the model information of the first model to the model information base. If model information of the model of the target information exists in the model information base, the kernel replaces the model information of the model of the target information in the model information base with the model information of the first model.

In addition, the model information that is stored in the model information base and that is of the model obtained by means of machine learning training may be an embodiment of a model, or may be identifier meta information corresponding to the model, or may be a user-defined function associated with the model. Using the first model as an example, the model information that is of the first model and that is stored in the model information base may be at least one of the following information: related column data, a model type, a quantity of layers of the model, a quantity of neurons, a function type, a model weight, a bias, an activation function, or a model state; or the model information of the first model is identifier meta information corresponding to the first model; or the model information of the first model is a user-defined function associated with the first model. In either a case of the identifier meta information corresponding to the model information or a case of the user-defined function associated with the model information, the kernel can obtain the first model.

In this embodiment of the present disclosure, when the database system includes the kernel and the external trainer, and the external trainer performs model training, the kernel is associated with the external trainer using the model information base stored in the kernel, and the model information of the first model is stored in the model information base after training of the first model is completed such that the kernel can directly perform, when performing query optimization, optimization according to the model information stored in the model information base.

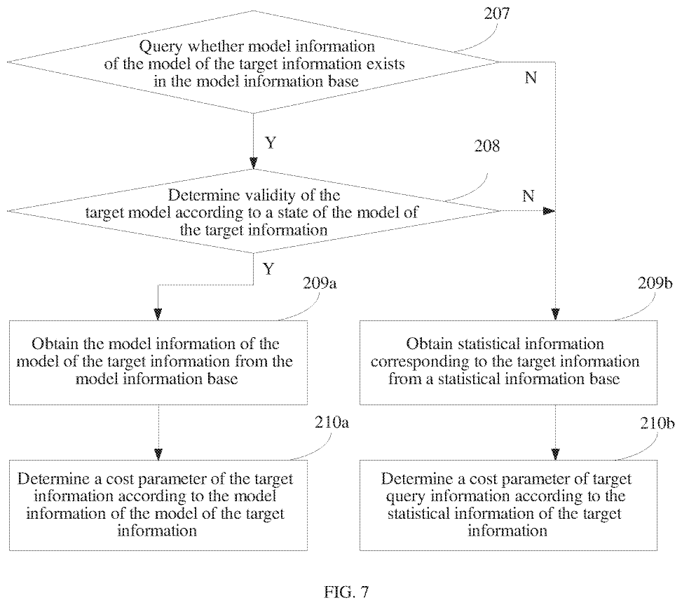

Further, referring to FIG. 7, when the kernel performs cost estimation on the target information, the kernel may perform cost estimation according to a method shown in FIG. 7. A cost estimation process shown in FIG. 7 and step 201 to step 206 are not limited to a fixed sequence.

Step 207: The kernel queries, according to the target information, whether model information of the model of the target information exists in the model information base.

When the kernel performs cost estimation on the target information, the kernel may also be referred to as an optimizer. The optimizer queries the model information base according to the target information to determine whether the model information of the model of the target information exists in the model information base. The model information of the model of the target information herein is the same as that in step 206. For details, refer to the foregoing description, and details are not described in this embodiment of the present disclosure again.

Step 208: If the model information of the model of the target information exists in the model information base, determine validity of the model of the target information according to a state of the model of the target information.

When the optimizer queries the model information base and determines that the model information of the model of the target information exists in the model information base, the optimizer may determine the validity of the model of the target information according to the state of the model of the target information. In an embodiment, the optimizer may determine the validity of the model of the target information according to state information in the model information of the model of the target information. For example, if the state information of the first model indicates that the first model is in the training state, the optimizer may determine that the state of the model of the target information is the invalid state. If the state information of the first model indicates that the first model is in a training completed state or the valid state, the optimizer may determine that the state of the model of the target information is the valid state.

The first model being in the invalid state means that the first model currently cannot be used to estimate a cost parameter. For example, when the first model is in the training state or an update state, it may be determined that the state of the first model is the invalid state. The state of the first model being the valid state means that the first model currently can be used to estimate the cost parameter, that is, training of the first model is completed, or model update is completed.

Step 209a: If determining that the state the model of the target information is a valid state, obtain the model information of the model of the target information from the model information base.

When the optimizer determines that the state the model of the target information is the valid state, the optimizer may obtain the model information of the model of the target information from the model information base. For example, the optimizer may obtain the model information such as a model weight or a bias of the model of the target information from the model information base.

Alternatively, when the optimizer determines that the state of the model of the target information is the invalid state, for example, the first model is in a model training process, the optimizer may postpone and wait, and not obtain the model information of the first model from the model information base until the state of the first model changes from the invalid state to the valid state.

Step 210a: Determine a cost parameter of the target information according to the model information of the model of the target information.

When the optimizer obtains the model information of the model of the target information, the optimizer may estimate the cost parameter according to the model information of the model of the target information. For example, when the target information is two related pieces of column data, and the model use of the first model is selectivity estimation, the optimizer may perform selectivity estimation according to the model information of the first model.

Further, referring to FIG. 7, after step 207, if a preset condition is satisfied, the method further includes: step 209b and step 210b. The preset condition is that the model information of the model of the target information does not exist in the model information base, or the model information of the model of the target information exists in the model information base and the state of the model of the target information is the invalid state.

Step 209b: Obtain statistical information corresponding to the target information from a statistical information base, where the statistical information base is used to store statistical information that is of query information and that is obtained by means of data sampling.

When the optimizer queries the model information base, if the optimizer determines that the model information of the model of the target information does not exist in the model information base, it indicates that the database management system does not perform model training on the model of the target information by means of machine learning. Alternatively, if the model information of the model of the target information exists in the model information base and the state of the model of the target information is the invalid state, it indicates that the database management system has performed model training on the model of the target information by means of machine learning before, but a newest model of the target information is still being trained or updated currently.

When model training is performed using a machine learning method, a relatively long time may be needed. To further avoid postponing and waiting by the optimizer, the optimizer may obtain the statistical information corresponding to the target information from the statistical information base. The statistical information base may obtain, by means of training, and store the statistical information of the target information using a conventional data sampling method.

Step 210b: Determine a cost parameter corresponding to the target information according to the statistical information corresponding to the target information.

The statistical information corresponding to the target information may be statistical information based on a histogram, a common value, or a frequency. When the optimizer obtains, from the statistical information base, the statistical information that is based on the histogram, the common value, or the frequency and that corresponds to the target information, the optimizer may estimate, according to the statistical information, the cost parameter corresponding to the target information in order to determine a minimum cost parameter.

Further, after the optimizer determines, according to step 210a or step 210b, the cost parameter corresponding to the target information, the optimizer may generate a corresponding execution plan according to the estimated minimum cost parameter, and enable an execution structure to perform, during operation, a data operation according to the execution plan having a minimum cost in order to improve performance of the database system.

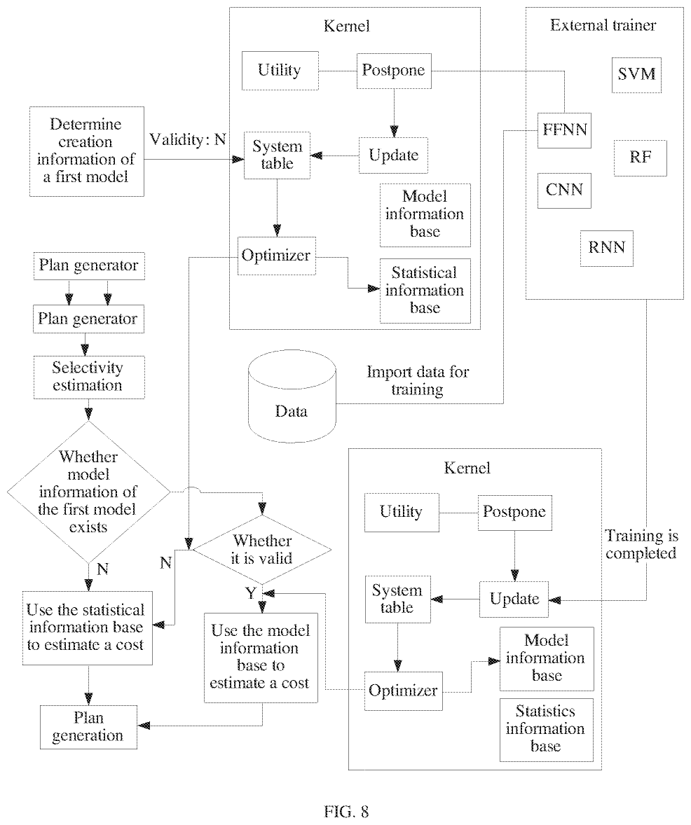

In an embodiment, as shown in FIG. 8, FIG. 8 is a schematic flowchart of performing the method provided in this embodiment of the present disclosure by a database management system. In FIG. 8, an example of a first model M1, a two-column selectivity (SEL2), and a training algorithm of a model being an FFNN is used as an example.

It should be noted that an internal architecture of the database management system shown in FIG. 8 may further be used to: perform model training and cost estimation during input/output (I/O) optimization, perform model training and cost estimation during central processing unit (CPU) optimization, and the like.

In this embodiment of the present disclosure, because model training by means of machine learning usually takes a very long time, the kernel and the external trainer are separately disposed, and the external trainer performs model training such that the kernel triggers, during statistical information collection, the external trainer to perform model training, and does not need to wait for a returned training result, thereby implementing asynchronization of statistical information collection and model training, and shortening a statistical information collection process. In addition, a kernel resource does not need to be occupied in a model training process, and the model information that is of the model and that is stored in the model information base is asynchronously updated after model training is completed such that a cost of cost selection of the kernel is decreased to be minimum while it is ensured that the cost parameter calculated according to the newest model information has relatively high accuracy.

The solution provided in the embodiments of the present disclosure is mainly described above from the perspective of a device. It may be understood that, to implement the foregoing functions, the device, for example, the database management system, includes corresponding hardware structures and/or software modules for performing the functions. A person skilled in the art should be easily aware that, in combination with examples of devices and algorithm steps described in the embodiments disclosed in this specification, the embodiments of the present disclosure may be implemented in a hardware form or a form of a combination of hardware and computer software. Whether a function is performed in a hardware manner or a manner of driving hardware by computer software depends on particular applications and design constraint conditions of the technical solutions. A person skilled in the art may use different methods to implement the described functions for the particular applications, but it should not be considered that the implementation goes beyond the scope of this application.

In the embodiments of the present disclosure, function modules in the database management system may be divided according to the foregoing method example. For example, the function modules may be divided corresponding to the functions. Alternatively, two or more functions may be integrated in a processing module. The foregoing integrated module may be implemented in a hardware form or a software function module form. It should be noted that division of the modules in the embodiments of the present disclosure is an example, and is merely division of logical functions. During an embodiment of an implementation, another division manner may be used.

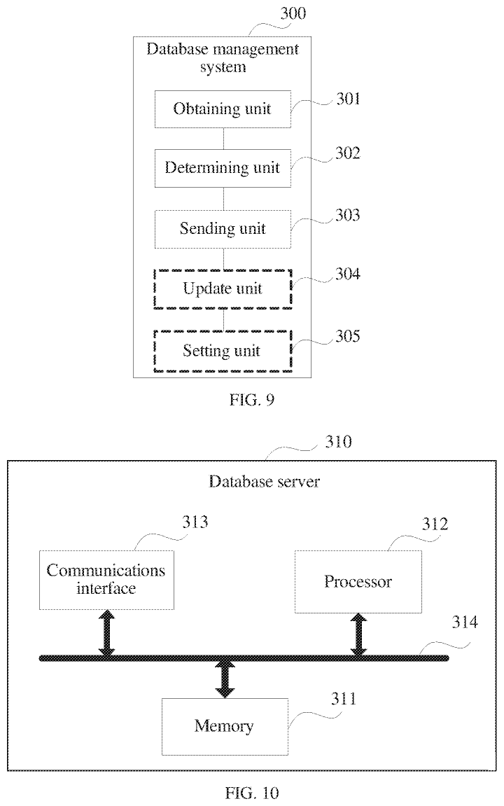

If the function modules are divided corresponding to the functions. FIG. 9 is a possible schematic structural diagram of a database management system related to the foregoing embodiment. The database management system 300 includes an obtaining unit 301, a determining unit 302, and a sending unit 303. The obtaining unit 301 is configured to perform step 201 in FIG. 4 and FIG. 6 and step 205 in FIG. 6. The determining unit 302 is configured to perform step 202 in FIG. 4 and FIG. 6 and step 207 to step 210b in FIG. 8. The sending unit 303 is configured to perform step 203 in FIG. 4 and FIG. 6. Further, the database management system 300 may further include an update unit 304. The update unit 304 is configured to perform step 206 in FIG. 6. The database management system 300 may further include a setting unit 305. The setting unit 305 is configured to perform a step of setting the state of the model of the target information to the invalid state and/or a step of setting the state of the model of the target information to the valid state. For all related content of the steps in the foregoing method embodiment, refer to function descriptions of the corresponding function modules, and details are not described herein again.

In a hardware implementation, the database management system may be a database server, the determining unit 302, the update unit 304, and the setting unit 305 may be a processor, the obtaining unit 301 may be a receiver, the sending unit 304 may be a transmitter, and the transmitter and the receiver may form a communications interface.

As shown in FIG. 10, FIG. 10 is a schematic diagram of a possible logical structure of the database server 310 in the foregoing embodiment provided in the embodiments of the present disclosure. The database server 310 includes: a processor 312, a communications interface 313, a memory 311, and a bus 314. The processor 312, the communications interface 313, and the memory 311 are mutually connected using the bus 314. In this embodiment of the present disclosure, the processor 312 is configured to control and manage an action of the database server 310. For example, the processor 312 is configured to perform step 202 in FIG. 4, step 202 and step 206 in FIG. 6, and step 207 to step 210b in FIG. 8, and/or another process used in a technology described in this specification. The communications interface 313 is configured to support the database server 310 to perform communication. The memory 311 is configured to store program code and data of the database server 310.

The processor 312 may be a central processing unit, a general purpose processor, a digital signal processor, an application-specific integrated circuit, a field programmable gate array or another programmable logic device, a transistor logic device, a hardware component, or any combination thereof. The processor 312 may implement or execute various examples of logical blocks, modules, and circuits described with reference to content disclosed in this application. Alternatively, the processor may be a combination implementing a computing function, for example, a combination including one or more microprocessors, or a combination of a digital signal processor and a microprocessor. The bus 314 may be a peripheral component interconnect (PCI) bus, an extended industry standard architecture (EISA) bus, or the like. The bus may be classified into an address bus, a data bus, a control bus, and the like. For ease of representation, only one thick line is used to represent the bus in FIG. 10, but this does not mean that there is only one bus or only one type of bus.

In another embodiment of the present disclosure, a computer readable storage medium is further provided. The computer readable storage medium stores computer execution instructions, and when at least one processor of a device executes the computer execution instructions, the device performs the information processing method shown in FIG. 4, FIG. 6, or FIG. 7.

In another embodiment of the present disclosure, a computer program product is provided. The computer program product includes computer execution instructions, and the computer execution instructions are stored in a computer readable storage medium. At least one processor of a device may read the computer execution instructions from the computer readable storage medium, and the at least one processor executes the computer execution instructions such that the device performs the information processing method shown in FIG. 4. FIG. 6, or FIG. 7.

In the embodiments of the present disclosure, when receiving the target information, the database server determines the creation information of the first model corresponding to the target information, and obtains the first model by means of machine learning training and according to the target information and the creation information of the first model such that model training is performed by means of machine learning and according to all the data in the database, and parameter information of a training parameter having relatively high accuracy is obtained. Further, when cost estimation is performed based on the parameter information, an execution cost of the database server can be decreased to be minimum, and execution efficiency of a data operation performed according to the execution plan having the minimum cost is improved.

Finally, it should be noted that, the foregoing descriptions are merely specific implementations of this application, but are not intended to limit the protection scope of this application. Any variation or replacement within the technical scope disclosed in this application shall fall within the protection scope of this application. Therefore, the protection scope of this application shall be subject to the protection scope of the claims.

What is claimed is:

1. A method of information processing implemented by a kernel in a database management system, wherein the method comprises:
obtaining target information in a database, wherein the target information comprises at least one of a target query statement, information about a query plan, distribution or change information of data, wherein the database is managed by either the database management system, system configuration or environment information;
determining creation information of a model of the target information according to the target information, wherein the model estimates a cost parameter of the target information, and wherein the creation information comprises use information of the model and training algorithm information of the model; and
sending a training instruction to an external trainer, wherein the training instruction instructs the external trainer to perform machine learning training on the data in the database according to the target information and the creation information so as to obtain a first model of the target information.

2. The method of claim 1, wherein the kernel comprises a model information base that stores model information of the model that is obtained by machine learning training, and wherein the method further comprises updating the model information base according to the first model.

3. The method of claim 2, wherein the determining comprises obtaining the creation information from the model information base according to the target information.

4. The method of claim 2, wherein the updating comprises:
adding first model information of the first model to the model information base; or
replacing, in the model information base, the model information with the first model information.

5. The method of claim 2, further comprising:
setting a state of the model to an invalid state after the determining; and
setting the state to a valid state after the model information base is updated according to the first model.

6. The method of claim 5, further comprising:
obtaining the model information from the model information base when the state is the valid state;
determining a cost parameter of the target information according to the model information; and
generating an execution plan having a minimum cost using the cost parameter.

7. The method of claim 5, further comprising:
obtaining, from a statistical information base, statistical information that corresponds to the target information when a preset condition is satisfied, wherein the statistical information is based on data sampling, and wherein the preset condition comprises that the model information does not exist in the model information base or the model information exists in the model information base and the state is the invalid state;
determining the cost parameter according to the statistical information; and
generating an execution plan having a minimum cost using the cost parameter.

8. The method of claim 2, wherein the model information of the first model comprises at least one of related column data, a model type, a quantity of layers of the model, a quantity of neurons, a function type, a model weight, a bias, an activation function, or a model state.

9. A database server for managing a database, comprising:
a memory storing instructions;
a processor coupled to the memory and configured to execute the instructions, wherein the instructions cause the processor to:
obtain target information in a database, wherein the target information comprises at least one of a target query statement, information about a query plan, distribution or change information of data, wherein the database is managed by either the system configuration or environment information;
determine creation information of a model of the target information according to the target information, wherein the model is configured to estimate a cost parameter of the target information, and wherein the creation information comprises use information of the model and training algorithm information of the model; and
send a training instruction to an external trainer, wherein the training instruction is configured to instruct the external trainer to perform machine learning training on the data in the database according to the target information and the creation information so as to obtain a first model of the target information.

10. The database server of claim 9, wherein the instructions further cause the processor to be configured to:
obtain the model by machine learning training;
store model information of the model in a model information base; and
update the model information base according to the first model.

11. The database server of claim 10, wherein the instructions further cause the processor to be configured to obtain the creation information from the model information base according to the target information.

12. The database server of claim 10, wherein the instructions further cause the processor to be configured to:
add first model information of the first model to the model information base; or
replace the model information in the model information base with the first model information.

13. The database server of claim 10, wherein the instructions further cause the processor to be configured to:
set a state of the model to an invalid state after determining the creation information of the model; and
set the state to a valid state after the model information base is updated according to the first model.

14. The database server of claim 13, wherein the instructions further cause the processor to be configured to:
obtain the model information of the model from a model information base when the model information of the model exists in the model information base and the state of the model is the valid state;
determine a cost parameter of the target information according to the model information of the model; and
generate an execution plan having a minimum cost using the cost parameter.

15. The database server of claim 13, wherein the instructions further cause the processor to be configured to:
obtain statistical information from a statistical information base when a preset condition is satisfied, wherein the statistical information corresponds to the target information, wherein the statistical information is based on data sampling, and wherein the preset condition comprises that the model information does not exist in the model information base, or the model information exists in the model information base and the state is the invalid state;
determine the cost parameter of the target information according to the statistical information; and
generate an execution plan having a minimum cost using the cost parameter.

16. The database server of claim 10, wherein the model information comprises at least one of related column data, a model type, a quantity of layers of the model, a quantity of neurons, a function type, a model weight, a bias, an activation function, or a model state.

17. A computer readable storage medium storing computer execution instructions which, when executed by at least one processor of a device, cause the device to:
obtain target information in a database, wherein the target information comprises at least one of a target query statement, information about a query plan, distribution or change information of data in either a database, system configuration or environment information;
determine creation information of a model of the target information according to the target information, wherein the model is configured to estimate a cost parameter of the target information, and wherein the creation information comprises use information of the model and training algorithm information of the model; and
send a training instruction to an external trainer, wherein the training instruction is configured to instruct the external trainer to perform machine learning training on the data in the database according to the target information and the creation information so as to obtain a first model of the target information.

18. The computer readable storage medium of claim 17, wherein the instructions further cause the device to obtain the creation information from a model information base according to the target information.

19. The computer readable storage medium of claim 18, wherein the instructions further cause the device to add first model information of the first model to the model information base, or replace the model information with the first model information.

20. The computer readable storage medium of claim 17, wherein the model information comprises at least one of related column data, a model type, a quantity of layers of the model, a quantity of neurons, a function type, a model weight, a bias, an activation function, or a model state.
